(19) United States
(12) Patent Application Publication
(10) Pub. No.: US 2018/0085826 A1
(43) Pub. Date: Mar. 29, 2018

(54) METHOD AND DEVICE FOR CONTROLLING PRINTING ZONE TEMPERATURE

(71) Applicant: TYCO ELECTRONICS CORPORATION, Berwyn, PA (US)

(72) Inventors: Xiaoming LUO, Painted Post, NY (US); Charles David FRY, New Bloomfield, PA (US); Michael F. LAUB, Enola, PA (US)

(21) Appl. No.: 15/278,661

(22) Filed: Sep. 28, 2016

(51) Int. Cl. B22F 3/105; B29C 67/00; B33Y 10/00; B33Y 30/00; B33Y 50/02; B23K 26/342; H05B 3/00; F24H 3/04

(52) U.S. Cl. CPC B22F 3/1055; B29C 67/0055; B29C 67/0088; B33Y 10/00; B33Y 30/00; B22F 2203/11; B23K 26/342; H05B 3/0061; F24H 3/04; B22F 2003/1057; B33Y 50/02

(57) ABSTRACT

A heating device and method for providing temperature control in an additive manufacturing processes. The heating device is positioned circumferentially about a print head and proximate a top layer of a printed object. An area of the top layer of the printed object is heated by directing energy from the heating device to the top layer as material is deposited from the print head onto the printed object. The directed energy applied to the printed object reduces distortion of the printed object caused by temperature gradients and improves the layer-to-layer bonding of the printed object.

### FIELD OF THE INVENTION

The present invention is directed to a method and device for providing temperature control in an additive manufacturing processes, to control the temperature distribution and the thermal gradient in a printed object.

### BACKGROUND OF THE INVENTION

Additive manufacturing devices, such as, but not limited to, three-dimensional printing devices are currently available to produce parts from such 3D data. Three-dimensional (3D) printing refers to processes that create 3D objects based on digital 3D object models and a materials dispenser. In 3D printing, a dispenser moves in at least 2-dimensions and dispenses material in accordance to a determined print pattern. To build a 3D object, a platform that holds the object being printed is adjusted such that the dispenser is able to apply many layers of material. In other words, a 3D object may be printed by printing many layers of material, one layer at a time. If the dispenser moves in 3-dimensions, movement of the platform is not needed. 3D printing features such as speed, accuracy, color options and cost vary for different dispensing mechanisms and materials.

A known system creates solid models or parts by depositing thermally solidifiable materials. In these processes, a flowable material is sequentially deposited on a substrate or on previously deposited thermoplastic material. The material solidifies after it is deposited and is thus able to incrementally create a desired form. Examples of thermally solidifiable systems include fused deposition modeling, wax jetting, metal jetting, consumable rod arc welding and plasma spraying. Such processes include Fused Deposition Modeling and Fused Filament Fabrication methods of 3D printing.

Since most deposition materials change density with temperature, these systems share the challenge of minimizing geometric distortions of the objects that are produced by these density changes. Thermally solidifiable systems are subject to both warping or curling and thermal stress and shock due to plastic deformation and the like. Curling is manifest by a curvilinear geometric distortion which is induced into a prototype during a cooling period. The single largest contributor to such a geometric distortion (with respect to prototypes made by the current generation of rapid prototyping systems which utilize a thermally solidifiable material) is a change in density of the material as it transitions from a relatively hot flowable state to a relatively cold solid state.

Techniques exist to reduce the impact of curl. One technique involves the heating of the ambient build environment to reduce the possible temperature differences. Another technique is to carefully choose build materials which exhibit lowest possible thermal expansion coefficients. Yet another technique is to deposit the build material at the lowest possible temperature.

The art is replete with various solid modeling teachings. For instance, U.S. Pat. No. 5,121,329 to Crump, and assigned to the same Assignee as this Application, describes a fused deposition modeling system. While the Crump system incorporates a heated build environment, it requires that the deposited material be below its solidification temperature, as subsequent layers of material are added. U.S. Pat. No. 4,749,347 to Vilavaara and U.S. Pat. No. 5,141,680 to Almquist et al. describe rapid prototyping systems that incorporate flowable, thermally solidifying material. Both patents teach a build environment that is maintained at and below the solidification temperature of the extrusion material.

Another known system and method, disclosed in U.S. Pat. No. 5,866,058 to Batchelder et al., calculates a sequence for extruding flowable material that thermally solidifies so as to create the desired geometric shape. A heated flowable modeling material is then sequentially extruded at its deposition temperature into a build environment that maintains the volume in the vicinity of the newly deposited material in a deposition temperature window between the material's solidification temperature and its creep temperature. Subsequently, the newly extruded material is gradually cooled below its solidification temperature while maintaining temperature gradients in the geometric shape below a maximum value set by the desired part's geometric accuracy.

Another known system, as disclosed in the RepRap open source initiative (an initiative to develop a 3D printer that can print most of its own components), discloses a heated build platform. Printing on a heated bed allows the printed part to stay warm during the printing process to allow more even shrinking of the plastic as it cools below melting point and facilitate adhesion.

However, while the controlled build environment or the existing heated beds provide some control over the warping or curling of parts or objects made by these techniques, warping and internal thermal stresses of the fabricated parts or objects continues to be a problem.

It would, therefore, be beneficial to provide an additive printing process in which the printing zone temperature is precisely controlled so that the temperature distribution and the thermal gradient in the printing zone can be controlled, thereby allowing the thermal stresses of the parts or objects to be lessened or eliminated while also reducing or eliminating issues with adhesion, expansion and shrinkage, layer-to-layer bonding, delamination and stress relaxation.

### SUMMARY OF THE INVENTION

An embodiment is directed to a heating device for providing temperature control in an additive manufacturing processes. The heating device includes a circular housing having an opening provided in the center of the housing for receiving a print head therethrough. The housing has a closed top surface and an open bottom surface. Heated gas is directed from the bottom surface of the housing to a printing zone of a printed object, wherein the directed heat applied to the printed object reduces distortion of the printed object caused by temperature gradients and improves the layer-to-layer bonding of the printed object.

An embodiment is directed to a heating device for providing temperature control in an additive manufacturing processes. The heating device includes a circular track having an opening provided in the center of the housing for receiving a print head therethrough. A laser device is movably positioned on the track. A laser head of the laser device is positioned to heat an area of a printed object in front of the print head as the print head is moved, allowing printed material of the printed object to be heated just before new printing material is applied.

An embodiment is directed to a method of providing temperature control in an additive manufacturing processes. The method includes: positioning a heating device circumferentially about a print head and proximate a top layer of a printed object; heating an area of the top layer of the printed object by directing energy from the heating device to the top layer as additional material is deposited from the print head onto the printed object. The directed energy applied to the printed object reduces distortion of the printed object caused by temperature gradients and improves the layer-to-layer bonding of the printed object.

Other features and advantages of the present invention will be apparent from the following more detailed description of the preferred embodiment, taken in conjunction with the accompanying drawings which illustrate, by way of example, the principles of the invention.

### BRIEF DESCRIPTION OF THE DRAWINGS

FIG. 1 is a perspective view of a print head of an additive manufacturing process with an illustrative heating device of the present invention provided proximate thereto.

FIG. 2 is a bottom perspective view of the heating device of FIG. 1, showing illustrative air foils positioned therein.

FIG. 3 is a perspective view of a print head of an additive manufacturing process with a second illustrative heating device of the present invention provided proximate thereto.

FIG. 4 is a bottom perspective view of the heating device of FIG. 3, showing an illustrative heating element positioned therein.

FIG. 5 is a perspective view of a print head of an additive manufacturing process with a third illustrative heating device of the present invention provided proximate thereto.

### DETAILED DESCRIPTION OF THE INVENTION

The description of illustrative embodiments according to principles of the present invention is intended to be read in connection with the accompanying drawings, which are to be considered part of the entire written description. In the description of embodiments of the invention disclosed herein, any reference to direction or orientation is merely intended for convenience of description and is not intended in any way to limit the scope of the present invention. Relative terms such as “lower,” “upper,” “horizontal,” “vertical,” “above,” “below,” “up,” “down,” “top” and “bottom” as well as derivative thereof (e.g., “horizontally,” “downwardly,” “upwardly,” etc.) should be construed to refer to the orientation as then described or as shown in the drawing under discussion. These relative terms are for convenience of description only and do not require that the apparatus be constructed or operated in a particular orientation unless explicitly indicated as such. Terms such as “attached,” “affixed,” “connected,” “coupled,” “interconnected,” and similar refer to a relationship wherein structures are secured or attached to one another either directly or indirectly through intervening structures, as well as both movable or rigid attachments or relationships, unless expressly described otherwise. Moreover, the features and benefits of the invention are illustrated by reference to the preferred embodiments. Accordingly, the invention expressly should not be limited to such preferred embodiments illustrating some possible non-limiting combination of features that may exist alone or in other combinations of features; the scope of the invention being defined by the claims appended hereto.

With respect to additive manufacturing, temperature distribution in a build or print zone or area plays an important role in building a part or object, in particular, but not limited to, a part or object with tight geometric tolerances. Many existing additive manufacturing apparatus lack adequate control over temperature distribution in the build or print area resulting in an undesired thermal gradient in the part or object being formed. The present invention solves the problems arising due to uncontrolled temperature distribution. Additionally, the present invention helps in controlling the adhesion, expansion and shrinkage, layer-to-layer bonding, stress relaxation, etc. of the part or object being built or fabricated.

Existing fused deposition modeling and fused filament fabrication methods used in three-dimensional printing have problems, such as, but not limited to, curling, warping and delaminating of the part or object being built. Contributing to these problems is uncontrolled shrinkage and expansion of the part or object during manufacture. The uncontrolled shrinkage and expansion results from uncontrolled temperature distribution, thermal gradient, thermal shock, residual stresses etc. in the part or object being built. The uncontrolled shrinkage and expansion may be present regardless of the materials (for example, but not limited to, thermally solidifiable materials, such as filled and unfilled polymers, high temperature thermoplastics or metals) used to build the part or object.

In order to overcome the problems of uncontrolled shrinkage and expansion, the build or print area of the present invention has a heating or temperature control mechanism or device provided proximate a print head which is controlled electronically, which optimizes the temperature control of the build or print area, which in turn optimizes the temperature control of the part or object being built.

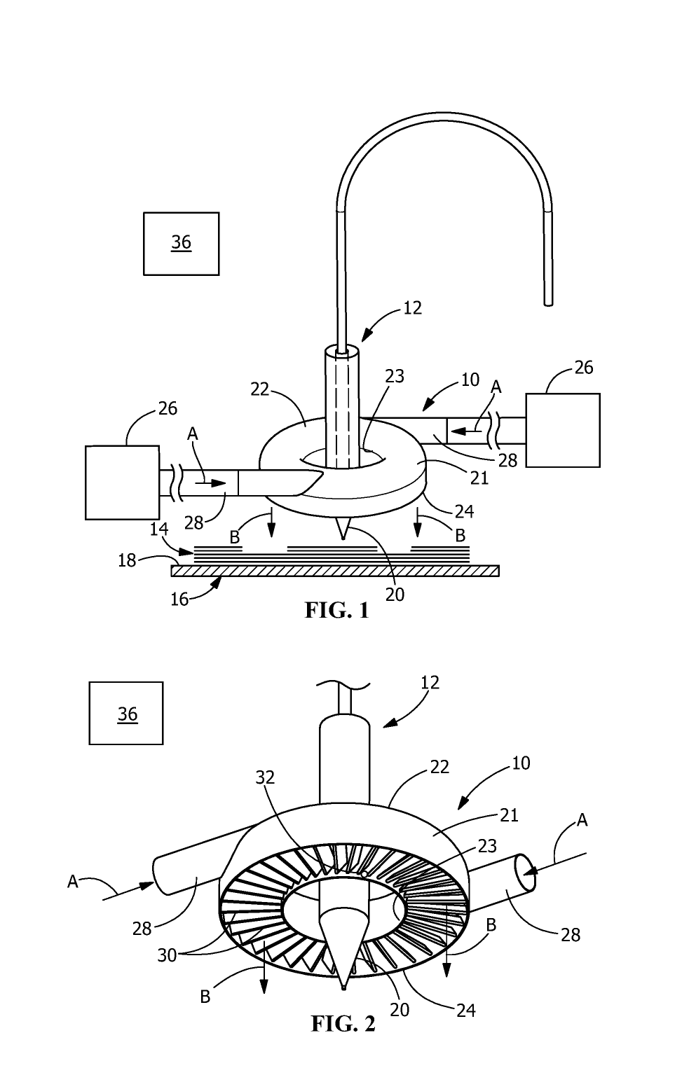

Referring to FIGS. 1 and 2, an illustrative embodiment of a convective printing zone heating device 10 is shown proximate to a print head 12 of a three-dimensional printing apparatus. The three-dimensional printing apparatus can be of any type known in the industry, including, but not limited, the apparatus shown in copending U.S. Patent Application Ser. No. 62/059,380, filed on Oct. 3, 2014, which is hereby incorporate by reference in its entirety. While a three-dimensional printing apparatus is shown, the printing zone heating device 10 may be used with various additive manufacturing processes.

The three-dimensional printing apparatus builds three-dimensional parts or objects 14 by depositing material from the print head 12 onto a build plate 16. As deposition of the material occurs, the print head 12 is moved in the x,y plane and the build plate 16 is moved along the z-axis. However, the movement of the print head 12 and/or the movement of the build plate 16 may occur in other directions without departing from the scope of the invention.

To support the part or object 14 as it is being built, the build plate 16 has an upper surface 18 to which the material deposited from the print head 12 will adhere. In some embodiments, a substrate is mounted on top of the build plate 16 upon which the part or object 14 is built. Use of a substrate allows for easy removal of the part or object 14 from the apparatus after completion thereof

In the illustrative embodiment shown in FIGS. 1 and 2, heating device 10 is provided proximate a print head 12. The heating device 10 has a generally circular and cylindrical shaped housing 21 with an opening 23 provided to receive and surround the print head 12. However, other configurations of the heating device 10 may be used. The heating device 10 is positioned circumferentially about the print head 12. The heating device 10 is positioned proximate to, but slightly removed from, the dispensing nozzle 20 of the print head 12. The top surface 22 of the heating device 10 is closed and has an arcuate configuration. The bottom surface 24 is open to allow heated gas to be directed downward toward the build plate 16 and the part or object 14 being formed.

The heating device 10 is a convective device which distributes heated gas at the specified temperature range to the build or print zone. The heated gas is generated by a heat exchanger 26 or other similar heating unit. The heated gas enters the heating device 10 through heated gas inlets 28. In the illustrative embodiment, two heated gas inlets 28 are provided to evenly distribute the heat in the heating device 10 and around the nozzle 20 of the print head 12. However, other numbers of inlets and heating units may be used without departing from the scope of the invention.

Multiple static air foils 30 are provided in the device 10 to direct the heated gas from the bottom surface 24. In the embodiment shown, the air foils 30 are uniformly spaced and extend from proximate the top surface 22 to proximate the bottom surface 24. The air foils 30 may be adjustable so that the air foils 30 can direct the heated gas from the bottom surface 24 of the heating device 10 in the direction required to heat the part or object 14. In addition, the number and spacing of the air foils 30 may vary depending upon the amount and direction of the heated gas desired.

Referring to FIG. 2, the heated gas enters into the heated gas inlets 28 as represented by arrows A. The heated gas flow through heating device 10 contacting the air foils 30, causing the heated air to be directed out of the heating device 10, as represented by arrows B. The heating device 10 is positioned proximate the nozzle 20 of the print head 12 such that the bottom surface 24 is parallel to and proximate build plate 16 and/or the top layer of the part or object 14 being formed. This allows the heated gas to be distributed parallel to build plate 16 in a 360 degree range from the heating device, thereby providing for even heat distribution to the build or printing area and that portion of the top layer of the part or object 14 which is being formed by the print head 12.

Temperature sensors 32 may be installed inside the heating device 10 or at other locations within the heated air supply channel to monitor the temperature of the heated gas. Flow parameters, such as flow speed and pressure of the heated gas that enters into the device gas inlets, are regulated with general fluid flow control devices, which will not be discussed in this invention.

The heating device 10 heats the ambient air proximate the nozzle 20 of the print head 12 by the convection of the heat and by natural convection. Alternatively, fans or blowers may be provided in the heating device 10 or at other locations within the heated air supply channel to more evenly distribute the heated gas and the heat radiating from the heated device 10. The ambient air heats the top layer or layers of the part or object 14.

The heating device 10 may be controlled by a controller 36 or similar device which controls various properties of the heating device 10 and heat exchanger 26. The heating device 10 may communicate with the controller 36 wirelessly or via fixed connections, such as, but not limited to, wires.

The heating device 10 is designed to distribute heated gas which is heated to a predetermined range of temperatures, such as, but not limited to 0 degrees Celsius to 240 degrees Celsius. However, the actual temperature achieved in the heating device 10 will be directly related to the type of material that is used to fabricate the part or object.

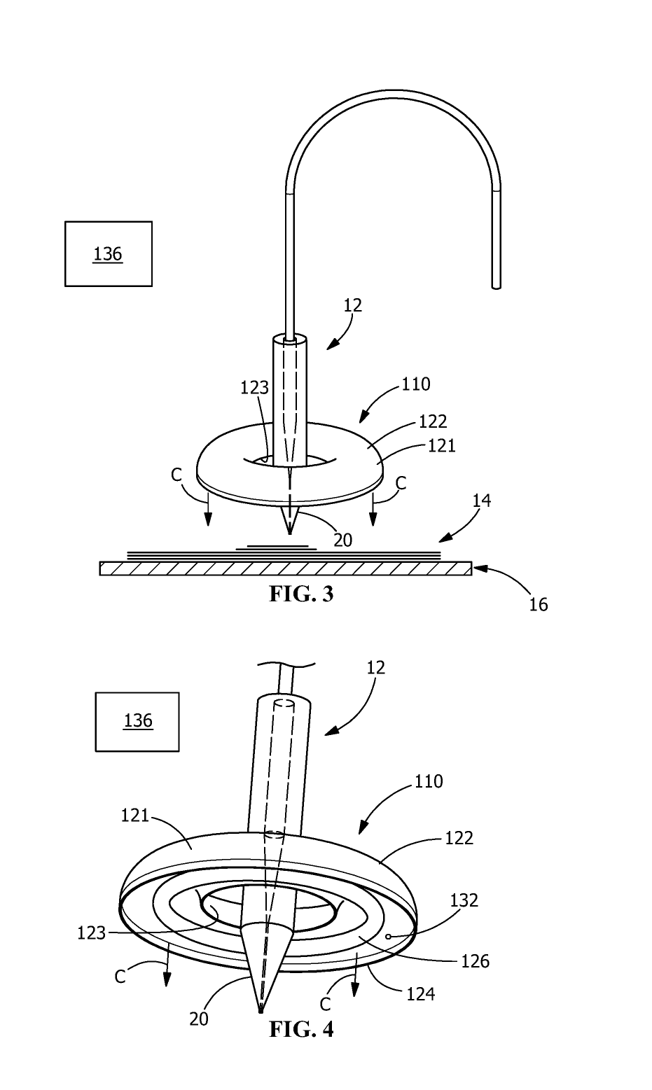

Referring to FIGS. 3 and 4, an illustrative embodiment of a radiative printing zone heating device 110 is shown proximate to the print head 12 of the three-dimensional printing apparatus. The heating device 110 has a generally circular and cylindrical shaped housing 121 with an opening 123 provided to receive and surround the print head 12. However, other configurations of the heating device 110 may be used. The heating device 110 is positioned circumferentially about the print head 12. The heating device 110 is positioned proximate to, but slightly removed from, the dispensing nozzle 20 of the print head 12. The top surface 122 of the heating device 110 is closed and has an arcuate configuration. The bottom surface 124 is open to allow radiated heat to be directed downward toward the build plate 16 and the part or object 14 being formed. The heating device 110 is reflective to facilitate the downward movement of the radiated heat.

The heating device 110 is a radiative device which distributes heated gas at the specified temperature range to the build or print zone. As best shown in FIG. 4, the heated gas is generated by a heating element 126. The heating element 126 may be held in place relative to the heating device 110 by molded retention members, retention straps, mounting hardware or other known methods of mounting. The heating element 126 may be powered by electrical current or other known power sources. In the embodiment shown, the heating element 126 is a circular member. However, the heating element 126 may have other configurations without departing from the scope of the invention.

The heating element 126 is powered, causing the heating element 126 to emit thermal energy through radiation to heat the gas which is proximate the heating device 110 and to heat the printed object. The heated gas radiates from the bottom surface 124, as represented by arrows C. The upper surface 122 is reflective and acts as a mirror to reflect the radiative thermal energy to the build or printing area or zone. Temperature sensors 132 may be installed inside the heating device 110 to monitor the temperature of the heated gas and the heating element 126.

The heating device 110 is positioned proximate the nozzle 20 of the print head 12 such that the bottom surface 124 is parallel to and proximate build plate 16 and/or the top layer of the part or object 14 being formed. This allows the heat and the heated gas to be distributed parallel to build plate 16 in a 360 degree range from the heating device 110, thereby providing for even heat distribution to the build or printing area and to that portion of the top layer of the part or object 14 which is being formed by the print head 12.

The heating device 110 heats the ambient air proximate the nozzle 20 of the print head 12 by the radiation of the heat and by natural convection. The ambient air heats the top layer or layers of the part or object 14. Additionally, as the heating device 110 emits energy as electromagnetic waves, the heating device 110 heats the object 14 directly. The heating device 110 may be controlled by a controller 136 or similar device which controls various properties of the heating device 110 and the heat element 126. The heating device 110 may communicate with the controller 136 wirelessly or via fixed connections, such as, but not limited to, wires.

The heating device 110 is designed to heated the ambient gas to a predetermined range of temperatures, such as, but not limited to, 0 degrees Celsius to 240 degrees Celsius. However, the actual temperature achieved in the heating device 110 will be directly related to the type of material that is used to fabricate the part or object.

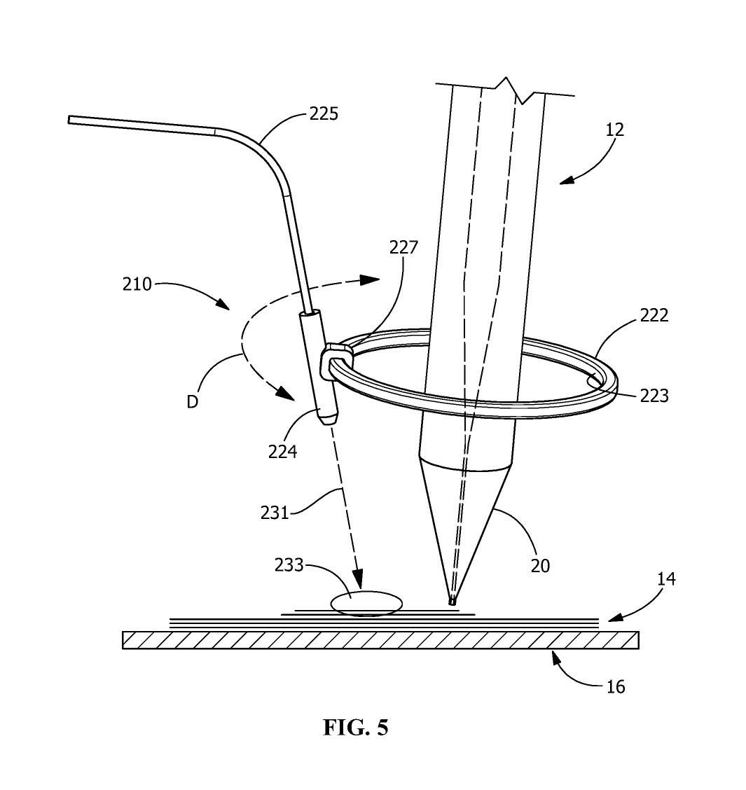

Referring to FIG. 5, an illustrative embodiment of a laser printing zone heating device 210 is shown proximate to the print head 12 of the three-dimensional printing apparatus. A guide track 222 of the heating device 210 has a generally circular shape with an opening 223 provided to receive and surround the print head 12. However, other configurations of the heating device 210 and guide track 222 may be used. The track 222 is positioned circumferentially about the print head 12. The heating device 210 is positioned proximate to, but slightly removed from, the dispensing nozzle 20 of the print head 12. The heating device 210 includes track 222 and laser head 224 which is connected to an optical fiber 225. The laser head 224 has a mounting arm 227 which is movably attached to the track 222, as represented by arrow D. The laser head 224 is mounted to be movable around the track 222. In addition, the laser head 224 is movable relative to the track 222, allowing the laser head to pivot or rotate relative to the track 222.

The heating device 210 is a laser device, in which the laser head 224 receives the laser beam from optical fiber 225, orientates the laser beam at the appropriate direction (as represented by 231) and positions/adjusts the laser beam to a suitable area or laser spot 233 size on the part or object 14 being formed.

The laser head 224 is able to move on the track 222 360 degree in a direction which is parallel to the build plate 16. The laser spot 233 is positioned in front of the print head 12 as the print head 12 and nozzle 20 are moved. This allows the previously printed material of the part or object 14 to be heated just before new printing material is applied to the spot. The size of the projected area or laser spot 223 and its position are adjustable through adjusting laser head 224 orientation and adjusting the laser focusing lens.

Alternatively, the laser head 224 may have a laser splitter to split the laser beam into multiple spots to achieve different heat zone shapes. One such illustrative shape is a donut shape, in which the laser printing position does not need to change with motion. The shapes can be controlled by switching the laser splitting mechanism.

Another variation has multiple laser heads 224 installed around the nozzle 20. In this embodiment, each laser head 224 projects a beam onto a portion of the part or object 14. Cumulatively, the beams cover around the nozzle 20. Respective laser heads 224 will be switched on and off during printing according to printing trajectory directions, such that no movement of laser heads is needed.

While the use of a laser head 224 is shown, the device 210 is not so limited. For example other types of heads may include, but are not limited to, a hot air pencil, a focused infrared source, a localized microwave source or a localized RF energy source. In all instances, the heating applied to the previous layers will predispose the previous layer to bond immediately before and/or during the extrusion process.

It has been determined that by maintaining a previously deposited material (for example, in a three-dimensional printing system utilizing thermal solidification) within a specific temperature window (which varies with the type of material used), that internal stresses present in the deposited material are relieved and geometric distortions reduced. At least in the vicinity of where newly deposited material will be applied, the previously deposited material must be maintained at a temperature that is preferably in a range between the material's solidification temperature and its relaxation temperature, which is defined as the temperature that the material is just sufficiently solid that fabrication can occur, while the internal stresses can relax without impacting part geometry.

By maintaining the temperature of the recently deposited material between the material's solidification temperature and its relaxation temperature, a balance is struck between the part or object being so weak that it droops and the part or object being so stiff that stresses cause geometric distortions. Further, inherent stresses are allowed to relax, leading to more dimensionally accurate models.

The apparatus and method described herein minimizes or avoids warp and distortion caused by temperature gradients. In addition, the layer-to-layer bonding of the printed material of the printed object is improved.

The method and an apparatus for the production of a three-dimensional printed object may be used in a build environment in which the ambient environmental temperature and the heating device temperatures are individually controlled, thereby allowing the two parameters in the printing process to be decoupled from each other. However, the use of the method and apparatus described herein may also be used in environments in which the ambient environmental temperature is not precisely controlled.

The method and apparatus can be used for the fabrication of parts or objects in both the fused deposition modeling process and the fused filament fabrication process. The printed object or objects may be formed from the deposition of thermally solidifiable materials, which include, but are not limited to, filled and unfilled polymers and high temperature thermoplastics.

While the invention has been described with reference to a preferred embodiment, it will be understood by those skilled in the art that various changes may be made and equivalents may be substituted for elements thereof without departing from the spirit and scope of the invention as defined in the accompanying claims. In particular, it will be clear to those skilled in the art that the present invention may be embodied in other specific forms, structures, arrangements, proportions, sizes, and with other elements, materials, and components, without departing from the spirit or essential characteristics thereof. One skilled in the art will appreciate that the invention may be used with many modifications of structure, arrangement, proportions, sizes, materials, and components and otherwise, used in the practice of the invention, which are particularly adapted to specific environments and operative requirements without departing from the principles of the present invention. The presently disclosed embodiments are therefore to be considered in all respects as illustrative and not restrictive, the scope of the invention being defined by the appended claims, and not limited to the foregoing description or embodiments.

1. A heating device for providing temperature control in an additive manufacturing processes, the heating device comprising:
a circular housing having an opening provided in the center of the housing for receiving a print head therethrough, the housing having a closed top surface and an open bottom surface;
heated gas is directed from the bottom surface of the housing to a printing zone of a printed object, wherein the directed heat applied to the printed object reduces distortion of the printed object caused by temperature gradients and improves the layer-to-layer bonding of the printed object.

2. The heating device as recited in claim 1, wherein the bottom surface of the heating device is parallel and proximate to a top layer of the printed object.

3. The heating device as recited in claim 1, wherein the heating device is a convective device.

4. The heating device as recited in claim 3, wherein the heating device has heated gas inlets.

5. The heating device as recited in claim 4, wherein one or more heat exchangers supply gas to the heated gas inlets.

6. The heating device as recited in claim 4, wherein static air foils extend between the top surface and the bottom surface, the static air foils direct the heated gas from the bottom surface.

7. The heating device as recited in claim 6, wherein the static air foils are uniformly spaced in the housing.

8. The heating device as recited in claim 6, wherein the static air foils are adjustable.

9. The heating device as recited in claim 1, wherein the heating device is a radiative device.

10. The heating device as recited in claim 9, wherein a heating element is positioned in the housing, the heating element emits thermal energy through radiation to heat the gas which is proximate the heating device.

11. The heating device as recited in claim 10, wherein the top surface has an arcuate configuration to reflect heat through the bottom surface.

12. The heating device as recited in claim 1 wherein temperature sensors are provided to monitor the temperature of the heated gas.

13. The heating device as recited in claim 1 wherein a controller is provided to control the heating device.

14. A heating device for providing temperature control in an additive manufacturing processes, the heating device comprising:
a circular track having an opening provided in the center of the housing for receiving a print head therethrough;
a laser device movably positioned on the track;
wherein a laser head of the laser device is positioned to heat an area of a printed object in front of the print head as the print head is moved, allowing printed material of the printed object to be heated just before new printing material is applied.

15. The heating device as recited in claim 14, wherein the laser head is adjustable relative to the track to allow the heated area to be adjusted.

16. The heating device as recited in claim 14, wherein the focus of the laser head is adjustable to allow the heated area to be adjusted.

17. The heating device as recited in claim 14, wherein multiple laser heads are positioned on the track.

18. A method of providing temperature control in an additive manufacturing processes, the method comprising:
positioning a heating device circumferentially about a print head and proximate a top layer of a printed object;
heating an area of the top layer of the printed object by directing energy from the heating device to the top layer as material is deposited from the print head onto the printed object;
wherein the directed energy applied to the printed object reduces distortion of the printed object caused by temperature gradients and improves the layer-to-layer bonding of the printed object.

19. The method as recited in claim 18, wherein the heating device is a convective heating device.

20. The method as recited in claim 18, wherein the heating device is a radiative heating device.

21. The method as recited in claim 18, wherein the heating device is a laser heating device.
